(19) United States
(12) Patent Application Publication
(10) Pub. No.: US 2008/0274391 A1
(43) Pub. Date: Nov. 6, 2008

(54) Multifunctional tunable metal-phosphate composite electrocatalyst for efficient oxygen reduction and methanol oxidation for applications in fuel cells and electrolysis

(76) Inventors: Rathindra N. Bose, DeKalb, IL (US); Anima B. Bose, DeKalb, IL (US)

Correspondence Address: KOHN & ASSOCIATES, PLLC, 30500 NORTHWESTERN HWY, SUITE 410, FARMINGTON HILLS, MI, 48334, US

(21) Appl. No.: 12/074,507

(22) Filed: Mar. 4, 2008

Related U.S. Application Data
(60) Provisional application No. 60/892,958, filed on Mar. 5, 2007.

(51) Int. Cl. H01M 4/00

(52) U.S. Cl. 429/40

(57) ABSTRACT

A thin-film electrocatalyst of a platinum phosphate composite surface, the platinum surface being entirely oxygen reductive. A tunable platinum phosphate composite surface, the platinum phosphate composite surface being entirely oxygen reductive. A substrate including deposited thereon the thin-film electrocatalyst. A fuel cell including at least one substrate.

### CROSS-REFERENCE TO RELATED APPLICATIONS

This application claims the benefit of priority under 35 U.S.C. Section 119(e) to U.S. Provisional Patent Application No. 60/892,958, filed Mar. 5, 2007, which is incorporated herein by reference.

### STATEMENT REGARDING FEDERALLY SPONSORED RESEARCH OR DEVELOPMENT

The invention was made possible by the United States' Federal Government support through a grant from the Department of Transportation under the contract number II-26-7006-01 to Northern Illinois University, DeKalb, Ill. 60115. The Government has certain rights in the invention.

### BACKGROUND OF THE INVENTION

(1) Field of the Invention

The present invention relates to new metal phosphate composite electrocatalysts for oxygen reduction that function by invoking a variety of oxidation states of platinum. In particular, the present invention relates to the use of new electrocatalysts as a cathode electrode for oxygen reduction as well as an anode electrode for methanol oxidation for fuel cell devices.

(2) Description of Related Art

Fuel cells are composed of cathodes and anodes which are functionally connected by an electrolyte. Reduction of oxygen takes place at the cathode and oxidation of hydrogen or other fuels take place at the anode. Depending on the nature of the electrolytes and selection of fuels, fuel cells are named as Proton Exchange Membrane Fuel Cells (PEMFC), Phosphoric Acid Fuel Cell (PAFC), Direct Methanol Fuel Cell (DMFC), etc. Two examples of the cathodic, anodic, and overall reactions of PEMFC and DMFC are shown below:

### Proton Exchange Membrane Fuel Cells (PEMFC):

$$\frac{\begin{matrix}Oxidation at anode ( anodic reaction ) \text{:} & {H}_{2} -> 2 {H}^{+} + 2 {e}^{-} \\ Reduction at cathode ( cathodic reaction ) \text{:} & 1 / 2 {O}_{2} + 2 {H}^{+} + 2 {e}^{-} -> {H}_{2} O\end{matrix}}{\begin{matrix}Overall oxidation \text{-} reduction reaction \text{:} & {H}_{2} + 1 / 2 {O}_{2} -> {H}_{2} O\end{matrix}}$$

### Direct Methanol Fuel Cells (DMFC):

$$\frac{\begin{matrix}Oxidation at anode ( anodic reaction ) \text{:} & {CH}_{3} OH + {H}_{2} O -> 6 H ++ 6 {e}^{-} + {CO}_{2} \\ Reduction at cathode ( cathodic reaction ) \text{:} & 3 / 2 O 2 + 6 H ++ 6 {e}^{-} -> 3 {H}_{2} O\end{matrix}}{\begin{matrix}Overall oxidation \text{-} reduction reaction \text{:} & {CH}_{3} OH + 3 / 2 {O}_{2} -> 2 {H}_{2} O + {CO}_{2}\end{matrix}}$$

As stated above, regardless of the nature of the fuel cells, an efficient reduction of oxygen is required for these energy generating devices. In practice, however, compressed atmospheric air, instead of pure oxygen, is fed into the cathode.

To efficiently reduce oxygen, catalysts are required. Although the most commonly used catalyst in fuel cells is platinum, there are problems associated with the catalyst. Sluggish kinetics of oxygen reduction and mass transport losses due to the poor transport of oxygen at the cathode surface are major problems encountered in the operation of fuel cells (3). The sluggish kinetics are often associated with irreversible oxide layer formation that also contributes to the deactivation of the catalyst (3). To overcome sluggish kinetics, a variety of precious, non-precious, and combinations of precious and non-precious metal catalysts including alloys have been developed, but none have been found to function better than the platinum catalyst in the highly demanding chemical environments in which fuel cells operate (3, 4, 6-8). In particular, these alloys and non-precious metal catalysts lose their activity relatively quickly due to a sintering effect in the acidic media of the fuel cell (3,4). The enhancement of mass transport of oxygen is inherently difficult due to the requirement of passing oxygen through the diffusion media.

To date, all prior art fuel cells almost exclusively include electrocatalysts that are capable of oxygen reduction with different degrees of efficiencies as judged by the production of power density per gram catalyst in fuel cells. These electrocatalysts are prepared on carbon supports by a variety of techniques including sputtering, vapor deposition, IBAD, pulse current electrodeposition, conventional mixing with a platinum loading ranging from 0.03 mg to 0.6 mg/cm2 (Patent references 1 through 4).

These platinum catalysts utilize an exposed metallic surface for oxygen binding for subsequent reduction. However, the catalyst surfaces are partially covered with hydroxide and oxide layers, as much as 50% (9), where oxygen cannot be anchored and hence a significant portion of the platinum surface remains inactive. Also, only a fraction of the bulk catalyst used in a mixture of carbon and other materials is actually engaged for oxygen reduction.

It has recently been discovered that cobalt (III) polymeric complexes can be used for oxygen reduction (Patent references 5 and 6). However, these complexes reduce oxygen at much lower potentials yielding much lower current densities. Platinum metallic surfaces are also poisoned by carbon monoxide due to the affinity for CO binding towards platinum metal. Furthermore, metallic platinum surfaces adsorb hydrogen so effectively that a major problem of hydrogen cross-over from anode to cathode during fuel cell operation is created. This hydrogen cross-over reduces the efficiency of fuel cells.

It would therefore be beneficial to develop a new active catalyst that overcomes the above-referenced problems by completely utilizing the entire surface of the catalyst, by eliminating coverage by hydroxide and oxide, by reducing the binding affinity of CO, and minimizing the hydrogen cross over problem.

### BRIEF SUMMARY OF THE INVENTION

The present invention provides for a thin-film electrocatalyst of a platinum phosphate composite and mixed metal phosphate surfaces, the platinum phosphate composite surfaces being entirely oxygen reductive.

The present invention further provides for a tunable platinum phosphate composite surface, the platinum phosphate composite surface being entirely oxygen reductive.

The present invention also provides for a substrate including deposited thereon the thin-film electrocatalyst, as well as a fuel cell including at least one substrate.

### BRIEF DESCRIPTION OF THE SEVERAL VIEWS OF THE DRAWINGS

Other advantages of the present invention will be readily appreciated as the same becomes better understood by reference to the following detailed description when considered in connection with the accompanying drawings wherein:

FIG. 1 is a structural formula of a representative precursor catalyst, a tetrameric mixed valence platinum complex as reported by Bose et al. (1,2);

FIG. 2 is a voltage scheme used to generate platinum phosphate catalysts on carbon substrates and the relative compositions of different oxidation states of platinum;

FIG. 3 shows one representation of the preparation of a membrane electrode assembly containing composite metal phosphate catalyst;

FIG. 4 is a graph of current potential curves generated from the thin-film platinum phosphate catalyst on carbon paper (0.08 mg/cm²) utilizing a three-electrode cell by using a voltage scanning rate 25 mV/s. The total geometric surface area exposed was 1.12 cm²;

FIG. 5 is graph of net current (oxygen saturated minus argon saturated cells)-potential curve demonstrating the oxygen reduction and presence of additional current after the reduction peak presumably due to water oxidation properties of the thin-film catalyst as in FIG. 4;

FIG. 6 is a cyclic voltammogram of oxygen reduction by a platinum phosphate composite catalyst on carbon cloth: the blue curve was recorded in argon while the red curve in the presence of oxygen, and the voltage scan rate was 25 mV/s.;

FIG. 7 is a cyclic voltammogram of oxygen reduction by a platinum phosphate composite catalyst on carbon rod: the blue curve was recorded in argon while the red curve in the presence of oxygen; the voltage scan rate was 5 mV/s and geometric area was 0.713 cm²; similar features were observed for all scan rates from 10-100 mV/s expect that currents were higher for higher scan rates;

FIG. 8 is cyclic voltammograms of an oxygen reduction reaction on commercial Pt-catalysts with comparable loadings as in FIG. 4: the blue curve was recorded in argon while the red curve in the presence of oxygen;

FIG. 9 is a graph of a rotating disk electrode voltammetry (900 rpm) of oxygen reduction by platinum phosphate composite catalyst (0.09 mg/cm²; geometric surface area 0.196 cm²): the blue curves are recorded in argon, red curves in oxygen, and the yellow curves are the net current due to oxygen reduction, and note that red and yellow curves overlapped due to the absence of platinum oxide layer;

FIG. 10 is a graph of rotating disk voltammetry of oxygen reduction by a commercial catalyst (0.25 mg Pt/cm²; geometric surface area 0.196 cm²) (Alfa Aesar, 40 wt % Pt/C) at 1600 rpm: the blue curves are recorded in argon, red curves in oxygen, and the yellow curves are the net current due to oxygen reduction;

FIG. 11 is a graph of hydrogen adsorption/desorption behavior (blue curve) for a platinum phosphate composite with predominant mixed valence platinum (II, III) species; the voltage scan rate was 10 mV/s;

FIG. 12 is a graph of hydrogen adsorption behavior (blue curve) for a platinum phosphate composite catalyst that contains ⅔ platinum metal and ⅓ mixed valence platinum (II,III) species; the voltage scan rate was 25 mV/s;

FIG. 13 is a graph of non-Resistance (IR) free and IR free performance curves of membrane electrode assembly (MEA) at 80 degrees C. operated on H₂/O₂ at 80/80/80 degrees C. of T_{cell}/T_{cathode humidity}/T_{anode humidity} operated at 100% relative humidity (RH);

FIG. 14 is graph of rotating disk voltammetry (1600 rpm) of oxygen reduction by platinum phosphate composite catalyst composed of predominantly mixed-valence species (0.05 mg/cm²) and augmented by ruthenium (<0.02 mg/cm²);

FIG. 15 is a graph of rotating disk voltammetry (1600 rpm) of oxygen reduction by platinum phosphate composite catalyst composed of predominantly mixed-valence species (0.05 mg/cm²; geometric area 0.196 cm²) and augmented by iron (<0.02 mg/cm²); and

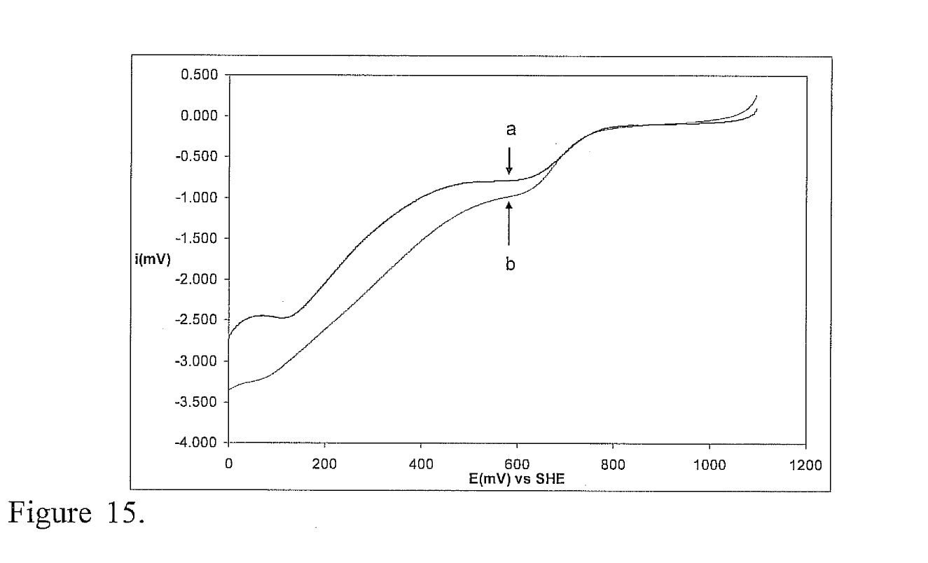

FIG. 16 is a current-voltage diagram for methanol oxidation by a platinum phosphate composite catalyst (pink) (0.08 mg/cm²) on carbon rod and by bare platinum metal (blue) of platinum oxide for the conventional platinum metal.

### DETAILED DESCRIPTION OF THE INVENTION

Generally, the present invention provides a major improvement of the existing electrocatalysts that are used in all types of fuel cell technology. More specifically, the present invention provides a thin-film electrocatalyst of a platinum phosphate composite surface, wherein the platinum phosphate composite surface is entirely oxygen reductive. In other words, the thin-film electrocatalyst is the platinum surface comprising of different platinum oxidation states bound to phosphate which can be formed on carbon and other conducting substrates. The platinum surface is a tunable active catalyst with a variety of compositions that range from phosphate coordinated metal ions to pure metallic formed from mixed valence platinum precursors by an electropolymerization technique.

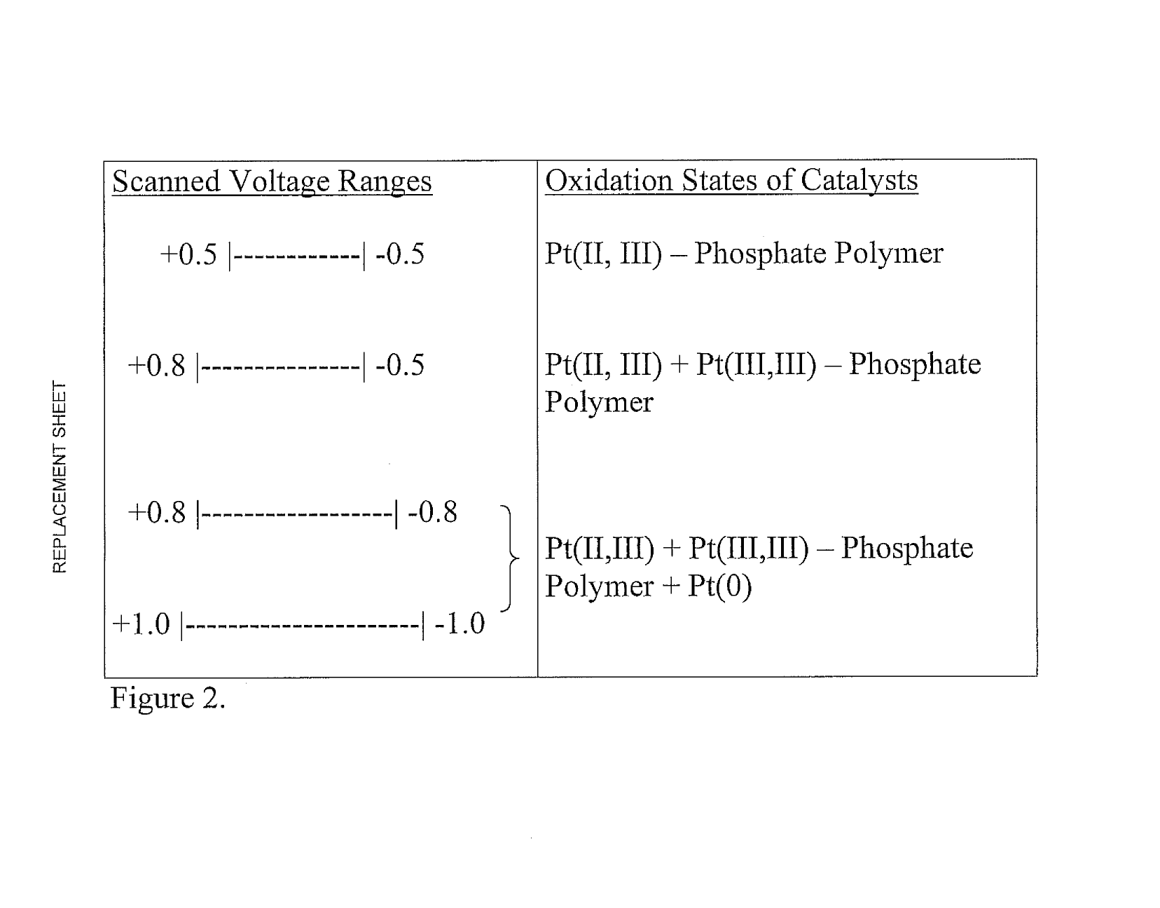

“Platinum surface” as used herein is interchangeable with “thin-film electrocatalyst” and is also referred to as being a “mixed-valence” surface, a “mixed-valence platinum phosphate layer”, or a “platinum phosphate composite surface”. In other words, the platinum surface of the present invention is prepared with platinum and optionally other transition metals of a variety of valences/oxidation states with chemically and physically bound phosphate moieties. The platinum surface is thus truly “tunable” based on the use of the platinum surface, such as for a fuel cell catalyst. The platinum surface is tunable because it can be designed with the desired valence states with variable compositions. For example, the platinum surface can be 1.00% platinum(II,III)-phosphate polymer, or a mixture of platinum(II,III)- and platinum(III,III)-phosphate polymer, or a mixture of platinum(II,III)-, platinum(III,III)-phosphate polymer, and platinum metal. The relative composition for each one of the components can be manipulated based on the selection of the voltage range during the preparation of the catalyst as shown in FIG. 2. Additionally, other non-platinum metals can also be coordinated on to the platinum phosphate composite surface. Therefore, one should be able to design a specific catalyst based on the desired needs. For example, a mixture of platinum(II,III)-, platinum(III,III)-phosphate polymer and platinum metal is expected to perform better for oxygen reduction by providing both metallic and ionic surface protected by phosphate moiety. On the other hand, methanol oxidation can be performed by the ionic surface without exposing CO poisoning the metallic surface.

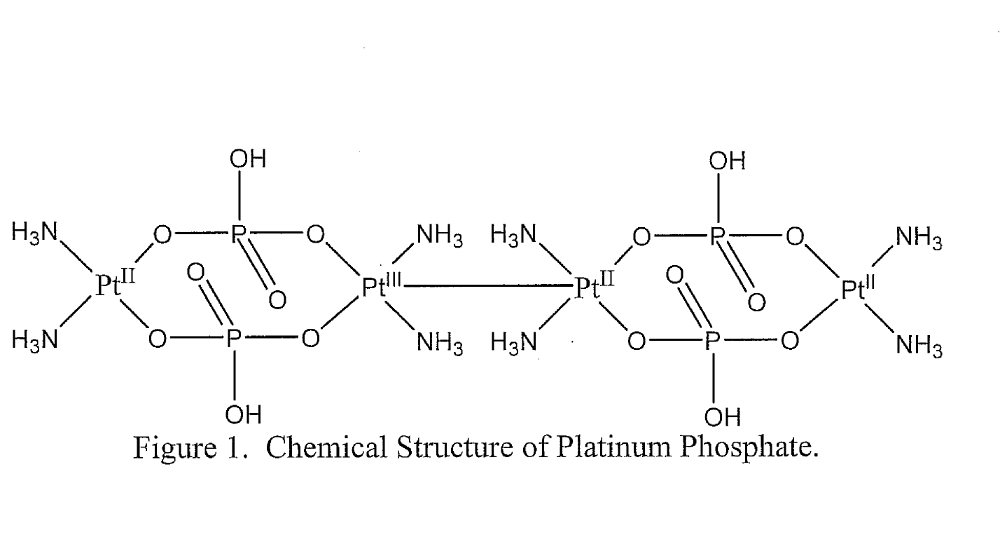

The present invention provides a metal phosphate composite multi-functional thin-film electrocatalyst for use on carbon substrates. The composite catalyst is capable of reducing oxygen and oxidizing methanol, and generating additional oxygen at the surface of the catalyst. Preferably, the catalyst is derived from mixed valence platinum oligomeric blue complexes including platinum phosphate blue shown in FIG. 1. These complexes were prepared following the method of Bose et al. (1,2). The platinum surface can have various oxidation states such as 0, (II), or (III). For example, the platinum surface can have an oxidation state of (II) and (III) and be bound to phosphate. However, alternative platinum compounds can be used without departing from the spirit of the present invention. Alternatively, the catalyst can include a mixed platinum and ruthenium surface. Other transition metals can also be mixed with platinum, such as chromium, cobalt, iron, nickel, palladium, and iridium.

The present invention includes the preparation and unique properties of thin-film mixed-valence platinum (II,II) and (III,III) surfaces coordinated by phosphate as electrocatalysts generated from the platinum phosphate precursor complex stated above. The unique properties are the combination of efficient oxygen reduction by engaging platinum (II) and platinum (III) oxidation states anchored to phosphate and methanol oxidation by minimizing carbon monoxide poisoning at the catalyst surface due to a reduced affinity to absorb carbon monoxide.

Phosphate protects the catalyst from oxidation at higher voltages, in the range 1.0-1.5 V where conventional catalysts substantially lose their activity, for durable performance. Phosphate also acts as a ligand (or binder) for tightly anchoring the metal ions of the electrocatalyst to a substrate. The phosphate has proton conducting properties to blend with the substrate, especially an ionomer, and is a required electrolyte to shuttle protons from anode to cathode.

The electrocatalyst of the present invention functions in the potential range of 1.1 to −0.2 V. vs. Standard Hydrogen Electrode. Further, the electrocatalyst is stable in highly acidic aqueous environments and does not significantly decompose in recycling potential between 1.5 V to 0.0 V over several thousand potential scans with 50 mV/s. The mixed-valence components of the composite electrocatalyst does not show any oxidation of platinum surfaces when voltage scan is reversed, i.e., starting from −0.4 to +1.5 V. The electrocatalyst can be deposited on the desired surface/substrate via a reductive electropolymerization process.

More generally, the catalyst is prepared on a substrate by depositing the thin-film electrocatalyst of the platinum surface onto the substrate by cycling voltages between two defined values, the platinum surface being entirely oxygen reductive. This method can be further defined as electropolymerizing and/or reductively electropolymerizing mixed valence platinum phosphate oligomer onto the substrate, and electrochemically depositing onto the substrate at least one transition metal of chromium, cobalt, iron, nickel, palladium, iridium, and ruthenium. Optionally, the resulting polymeric metal complex can be partially reduced to form platinum metal.

Thus, the present invention provides for a substrate including deposited thereon the thin-film electrocatalyst described herein. The substrate can include, but is not limited to, graphite carbon, carbon paper, porous carbon powder, and carbon cloth. Preferably, the thin-film electrocatalyst is present on the carbon substrate in the amount of 0.03 mg/cm² to 0.22 mg/cm². Alternative, other types of substrates can also be used.

The thin-film electrocatalyst is prepared by cycling different voltage ranges that include 1.0 to −1.0 V versus Ag/AgCl standard hydrogen electrode using electropolymerization technique utilizing (1,5) cyclic voltammetry methodology in order to deposit the thin-film electrocatalyst onto a carbon substrate. The scan rate is preferably between 5 mV/s and 50 mV/s. The activated electrocatalyst can be loaded as thin-film materials with variable loading from 0.03 mg/cm² to 0.22 mg/cm² from the precursor complex. However, the distribution of oxidation states such as Pt(0), Pt(II,II) etc. depends on the selection of the voltage range. For example, catalysts prepared by scanning voltage from +0.5 to −0.5 V provided no Pt(0), only mixed valence Pt₂(II,III) species. Scanning potential to a wider range 1.0 to −10 V creates, Pt₂(II,III), Pt₂(III,III) and Pt(0) species on the electrode surface. Furthermore, additional metals can be anchored on the electrode surface. Additionally, unlike all other conventional electrocatalysts, overloading platinum phosphate composite on carbon surfaces above 0.1 mg/cm² of platinum does improve the catalystic activity as evidenced by the lack of proportional enhancement of oxygen reduction current. This optimal performance at low catalyst loading is the evidence of utilization of entire available catalytic surface of the thin film. Additional loading of catalyst does not render more catalytic surface areas.

In general, the thin-film electrocatalyst of the present invention can be used to reduce oxygen. The thin-film electrocatalyst is deposited on a carbon substrate cathode, and oxygen is reduced by using the entire platinum surface of the thin-film electrocatalyst. Oxygen can be reduced from several sources, including, but not limited to, air and water. The composition of the platinum surface also prevents hydrogen adsorption thereon, further discussed below.

The electrocatalyst utilizes an activated mixed-valence platinum phosphate layer of the thin-film surface to reduce oxygen from air to form water and to oxidize methanol to form CO₂ and water. The present invention provides for a method of oxidizing methanol, including the steps of depositing the thin-film electrocatalyst on a carbon substrate cathode, reducing oxygen from air by using the entire platinum surface of the thin-film electrocatalyst; and oxidizing methanol on an anode.

The electrocatalyst functions as a fuel cell cathode for reducing oxygen with potential to generate high power density. The electrocatalyst enhances oxygen reduction in water as presumably utilizing water as an oxygen source and therefore has the potential to reduce water management problem in the Proton Exchange Membrane Fuel Cell.

Thus, the present invention includes a fuel cell having a membrane electrode assembly with at least one substrate including deposited thereon the thin-film electrocatalyst described herein. The fuel cell, as described conventionally also in the Example below, can be further defined as including three-phase components of a carbon powder, an ionomer proton conductor), and the thin-film catalyst deposited thereon.

The present invention has advantages over conventional catalysts and can increase the power density of fuel cells due to (1) offering several active catalysts as a composite to reduce oxygen as well as larger active surfaces to reduce oxygen because the entire platinum surface, not just a portion of it, is engaged in oxygen reduction, (2) minimizing inactive hydroxide and oxide layers of platinum due to incorporation of bound phosphate to platinum(II) and platinum(III) oxidation states, (3) minimizing loss of catalytic activity by preventing oxidation of platinum that takes place at more positive potentials, (4) minimizing hydrogen cross-over problems because the mixed-valence surface minimizes hydrogen adsorption/desorption properties, and (5) enhancing lifetime by minimizing carbon monoxide reduction, with or without additional catalysts. A further advantage of this invention is that the electrocatalyst effectively oxidizes methanol and hence can also be used as an anode-catalyst for the methanol oxidation. The invention utilizes sub-milligrams of platinum per square centimeter and therefore reduces the cost of the catalyst. In fact, an increase of platinum content in the platinum phosphate composite over 0.1 mg/cm² does not increase the power density proportionally. Hence this invention will potentially reduce the cost of fuel cell. Finally, the steady-sate current-voltage responses indicate lack of depletion of oxygen when oxygen supply is limited indicating a process of generating additional oxygen presumably from water, hence the electrocatalyst will help alleviate mass transfer problems and managing the water flooding problem in a membrane electrode assembly.

The invention is further described in detail by reference to the following experimental examples. These examples are provided for the purpose of illustration only, and are not intended to be limiting unless otherwise specified. Thus, the present invention should in no way be construed as being limited to the following examples, but rather, be construed to encompass any and all variations which become evident as a result of the teaching provided herein.

### EXAMPLE 1

### Preparation of Platinum Phosphate Composite Thin-Film Electrocatalyst

Platinum phosphate composite thin-film surfaces on carbon support are prepared from electropolymerization and reductive electropolymerization of platinum phosphate blue by cycling voltages between two predetermined values as described below. Typically, a three-electrode cell with a variety carbon surfaces as a working electrode, saturated calomel or Ag/AgCl as a reference electrode, and a platinum wire as an auxiliary electrode was used to prepare thin-film surfaces. The carbon surfaces include graphite carbon, carbon papers, carbon powder (Vulcan XC72R) on carbon cloth, and carbon cloths (E-TeK). To prepare the catalyst on carbon surfaces, three-electrode cells contained 1.0 to 5.0 mM platinum phosphate blue solution in 0.5 M NaClO4 at pH 4 to 5. Thin-films of different platinum loadings (0.03 to 0.22 mg/cm²) were prepared by cycling voltage from 1.0 to −1.0 V vs. Ag/AgCl with different scan rates, 5 mV/s to 50 mV/s. Other potential ranges between 0.8 to −0.8 V, 0.5 to −0.5 V, vs. Ag/AgCl were also used in conjunction with scan rates 5 to 50 mV/s to deposit the thin-film. An ink was prepared by emulsifying the carbon powder in 30 wt % NAFION® (from 5 wt % NAFION® solution purchased from Dupont, (DE 521, an ionomer) in isopropyl alcohol for 5-7 days. The resulting ink was then coated on a tip of rotating disk electrode and dried under an IR lamp. The mixed-valence platinum phosphate thin-film was then deposited on to the dried carbon-NAFION® matrix substrate by cycling the voltage stated above. The selection of number of cycles, scan rates, and starting concentrations of the precursor complex controlled the desired platinum loading of the thin-film surfaces. This unique method of thin-film formation is described in an earlier patent application (Patent reference 1) and published recently in the Journal of the Power Sources (5). However, the previous patent application and subsequent publication dealt with making thin-film of metal surfaces by completely reducing metal ions. The current application entails making composite surfaces with a variety of oxidation states and demonstrating the applications of these composite thin-films in fuel cell systems. In making these composite surfaces, the adsorption properties and complex electrochemistry of the phosphate blue precursor complex have been exploited. For example, the mixed valence Pt₂(II,III) species is easily polymerized on carbon surface by applying voltage <−0.4 V, reduced to Pt(II,II) at −0.72 V, and completely reduced to platinum metal at potential below −0.97 V vs. Ag/AgCl. The same mixed valence species can be oxidized to Pt₂(III,III) at voltage >0.5 V. Therefore, by selecting specific range of potentials, composite surfaces of desired oxidation states can be prepared. Moreover, the cycling technique allows one to discard any loosely bound platinum species by oxidizing the surface at positive potentials.

The platinum content was quantitatively estimated by atomic absorption spectroscopy and the amount of phosphate was determined as phosphomolybdate. These estimations revealed that depending on the range of voltage selected, the platinum/phosphate ratio varies. For example, the composite catalyst shows 1:1 platinum:phosphate ratio for the catalyst generated by scanning potential between 0.5 to −0.5 V. vs. Ag/AgCl while those prepared from 1.0 to −1.0 V vs. Ag/AgCl yielded phosphate/Pt ration as low as 0.3 on carbon road. The composite catalysts prepared by scanning 0.5 to −0.5 V predominantly yielded mixed-valence Pt₂(II,III) species. On the other hand, potential range 0.8 to −0.8 V afforded a combination of Pt₂(II,III) and Pt₂(III,III) along with small fraction of platinum metal. Finally, the scanning of wider potential range such as 1.0 to −1.0 or higher (both positive and negative) yielded significant amount of platinum metal along with Pt₂(II,III) and Pt₂(III,III).

### EXAMPLE 2

### Preparation of Mixed Metal Composite Catalyst

Once the platinum-phosphate is anchored in Example 1, the surfaces were further coated with other metals in the following manner. In this process, a platinum coated electrode was used as a working electrode and desired metals were deposited from dilute solutions (2-5 mM) from their respective metal salts via scanning potential from −1 to 1 V vs. Ag/AgCl. For example, Fe(III) acetate, Co(III) acetate/phosphate, Pd(II) chloride, Ru(III) chloride were used to coat respective metals. The extent of coating can be manipulated by the choice of concentration of the metallic salts and the number of cycles for coating them.

### EXAMPLE 3

### Preparation of Membrane Electrode Assembly Containing Composite Metal Phosphate Catalyst

Membrane electrode assemblies (MEAs) of 5 cm² active area were prepared from NAFION-115®, three different cathode Gas Diffusion Electrodes (GDE), and a common anode electrode as described below. First GDE was prepared from the carbon-ionomer ink described in Example 1 on wet-proof carbon cloth substrate. After spraying the ink on wet-proof carbon cloth, composite catalyst of desired loading was accomplished by electropolymerization on the ionomer-carbon surface as described in Example 1.

Second, carbon cloth (E-Tek) with no wet proofing was wet-proofed by dipping in a solution of PVDF (polyvinylidene fluoride) and NMP (N-methypyrrolidine) and stirred for approximately 4 hours. Carbon cloth was then taken out of the dispersion and dried in a conventional oven at temperatures of 150° C. for about 2 hours to remove any solvent remaining on the surface of the cloth. To localize the Pt particles on the electrode surface and to have a good three-phase interface, the following ink was prepared and sprayed: Vulcan carbon XC 72 R was treated in an oven at 280° C. for 2 hours to remove any organic matter. The pretreated carbon was then mixed with 10 weight % PVDF, which was first dissolved in NMP solution to ensure that the PVDF is completely dissolved, and doesn't form any clusters with carbon ink. Three milliliters of isopropanol were mixed with the solution. 20 weight % of 5 weight % NAFION® solution was also poured into the solution and was allowed to stir on the hot plate overnight. The resulting mixture was then applied on the dried wet-proofed carbon cloth; the weight of the mixture deposited was observed to be 15 mg. The leftover mixture was then mixed with glycerol and applied on the surface of the cloth to make the surface of the cloth hydrophilic in nature. The weight of the mixture deposited was observed to be around 5 mg. Then the cloth was dried in the oven at 250° C. for 2 hours. The un-catalyzed carbon electrode was then coated with platinum using the electro-polymerization technique with 5 mV/s scan rate and 10 cycles from 2.8 mM precursor complex solution. After the electro-polymerization the electrode was dried in the oven at 150° C. for 2 hours. The electro-polymerized electrode was then impregnated with the NAFION® dispersion by spraying. This was followed by drying at 80° C. for 2 hours.

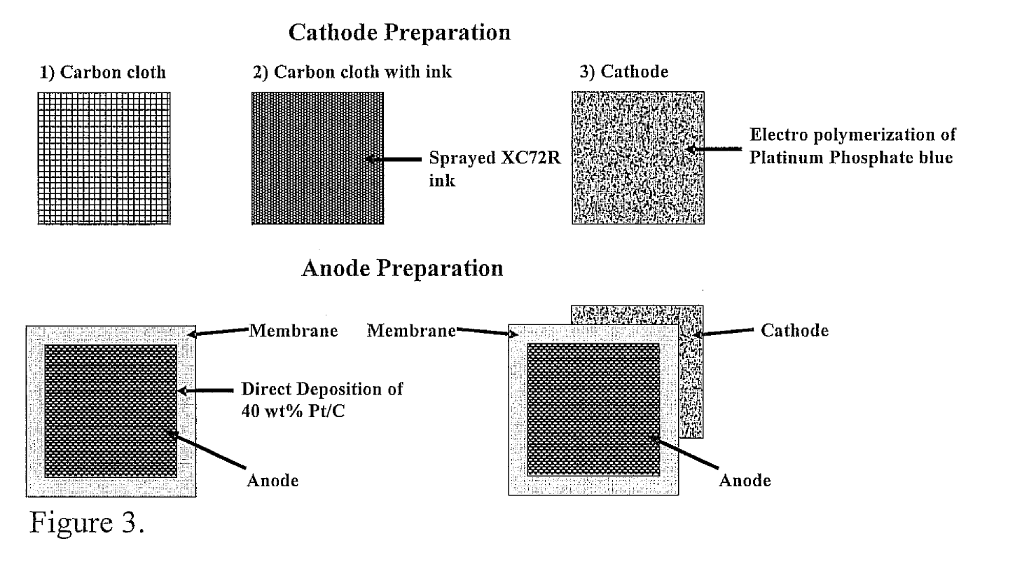

Third, electrocatalyst was loaded directly on non-wet-proofed carbon cloth (E-Tek) using the electro-polymerization technique for the cathode catalyst preparation as illustrated in FIG. 3.

For the anode, commercially available catalyst was used. The catalyst ink was directly sprayed on the as-purchased NAFION-115® membrane, without any pre-treatment, using the spray gun under a high voltage infrared lamp. The catalyst ink was prepared by adding 3 mL of deionized water to 0.5 g of 40 weight % Pt/C (Alfa Asear) and stirred in an ultrasonicator for one minute. Five strokes of spray were made on the membrane, with a five-minute time interval between each spray. The resulting weight of the deposited mixture was approximately 4-5 mg, which gave a Pt loading of 0.25 mg/cm². The NAFION® membrane with the anode electrolyte sprayed was then taken to the hot press, along with the prepared GDE, which was kept on the other side of the membrane as cathode.

The whole assembly was pressed at 150° C. for 5 minutes at 1000 pounds over a 36-square-inch plate.

### EXAMPLE 4

### Testing of Electrocatalyst for Oxygen Reduction Reaction

The electrocatalyst was tested in a three-electrode electrochemical cell comprised of a working electrode containing a thin-film of the catalyst deposited on carbon paper (E-TeK), cloth, or rod, a reference electrode (Hg/HgSO4 or Ag/AgCl), and an auxiliary electrode (Pt wire/foil or Au wire/foil). The electrocatalyst was also tested in a three electrode electrochemical cell comprised of working electrode containing thin-film electrocatalyst on graphite rod, carbon cloth, and other forms of carbons, including glassy carbon surfaces. The electrocatalyst was also tested on a mixture of porous carbon and NAFION® mixture conventionally used for fuel cell electrode materials for mounting the electrocatalyst as described below.

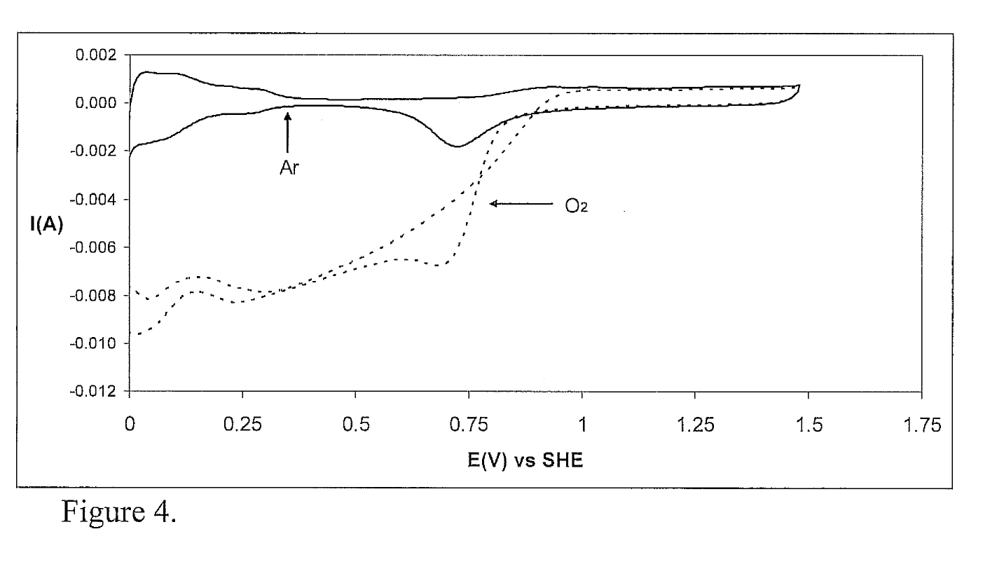

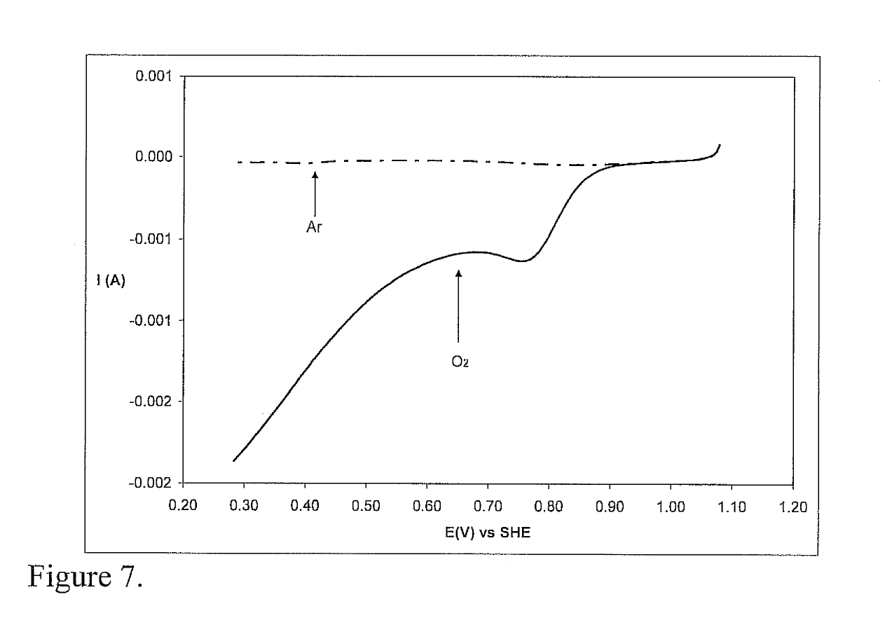

To demonstrate the properties of the thin-films of the present invention, both rotating disk electrode (RDE) voltammetry and steady-state voltammetry experiments were performed. Typically, a three-electrode cell with platinum catalyst on carbon support (0.03 to 0.22 mg/cm² platinum as deposited from the precursor complex) as the working electrode, a Hg/HgSO4 as a reference electrode, and a gold or platinum foil as an auxiliary electrode was used. The electrochemical cells contained 0.6 M HClO4 as an electrolyte and were saturated with oxygen before recording current as a function of scanning potentials in the range 1.5 V to 0. V. versus SHE. Experiments were also carried out by saturating the cells with argon gas. In RDE experiments, the electrodes were rotated between 400 and 1600 rotation per minute (rpm). Representative oxygen reduction properties are displayed in FIGS. 4-8 on various carbon surfaces stated in Example 1 and their superior characteristics are elaborated below. FIGS. 4-6 and 8 are further described herein. In FIG. 7, the scanning rate was 10 mV/s. The blue plot is taken in the absence of oxygen (argon purged) and the red curve is in the presence of oxygen. Note that the current continues to grow beyond the peak potential at 0.75 V due to additional reduction of oxygen.

### EXAMPLE 5

### Demonstration of the Lack of Deactivation of Catalyst at Potential Higher than 1.0 V

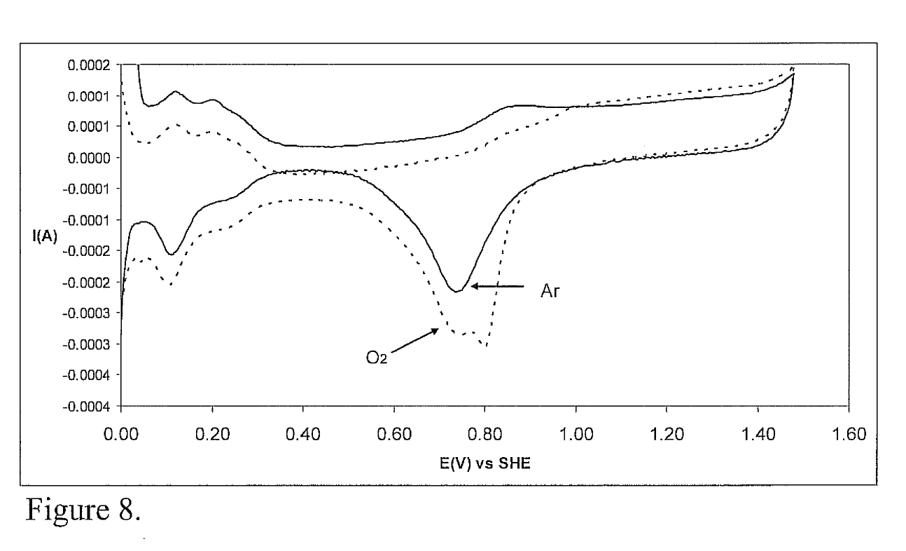

The superior properties of platinum phosphate composite catalyst can be seen by comparing FIGS. 4 and 8. FIG. 8 shows the current-potential curve in argon and oxygen purged solution for the commercial catalyst (0.1 mg/cm²). In FIG. 8, blue and red curves were recorded in the presence of saturated argon and oxygen atmosphere. Note that the decline in current after the peak potentials (0.75 V) is quite substantial. In fact, at 0.4 V, the current almost approaches zero. The forward scan (positive potential to negative potential) in argon solution shows a peak at 0.8 V due to the reduction of platinum oxide. In the oxygen purged solution, the current rapidly increases below 0.85 V and levels off below 0.8 V vs. SHE. This increase in current is due to the reduction of oxygen. FIG. 4 shows the same experiments with the newly developed platinum phosphate composite catalysts. As can be seen from FIG. 4, there is small reduction peak of platinum oxide in argon which usually appears at about 0.8 V vs. SHE. The oxygen reduction is seen by the rapid rise of current below 0.8 V and leveling off at about 0.6 V. Note that the platinum content in this new platinum phosphate composite catalyst electrode is 0.08 mg/cm², less than the commercial electrode in FIG. 8, yet the net current is almost double that of the commercial catalyst.

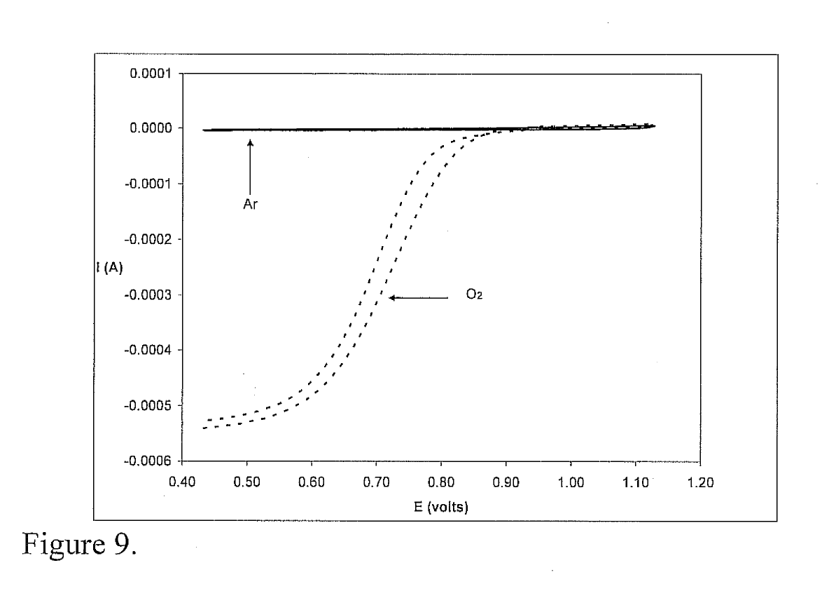

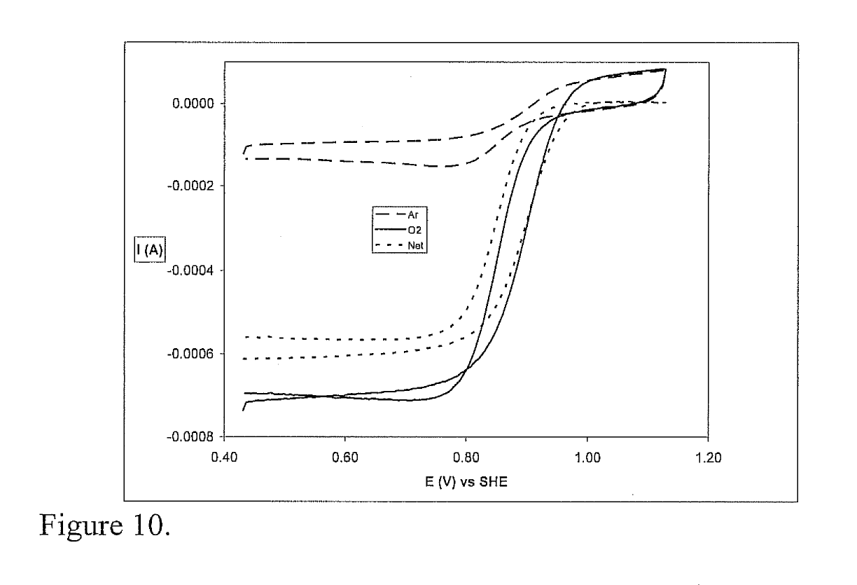

As indicated earlier, conventional platinum catalyst forms oxide layer which is not an active catalyst for oxygen reduction and detrimental for fuel cell operation. This oxide formation is severe when the potential increases above 1.0 V due to the oxidation of platinum metal. FIGS. 9 and 10 show current-voltage curves recorded by RDE technique both for mixed-valence platinum phosphate catalyst and one of the conventional platinum catalyst (platinum on carbon; 40% Pt by weight). In FIGS. 9 and 10, the blue line was taken in the presence of argon and red in oxygen. The yellow curve represents the net current due to oxygen reduction. Note that there is no significant current in argon purged due to the lack of formation of platinum oxide. Note that significant oxidation of the commercial catalyst is observed above 1.0 V due to the presence of oxidation current (FIG. 10) while such oxidation is virtually absent in the platinum phosphate catalyst (FIG. 9). Also, note that platinum loading for the commercial catalyst is 2.5-fold higher than the new developed platinum phosphate composite catalyst. Lack of deactivation of the platinum phosphate composite catalyst is also seen in FIG. 4 where the voltage was increased to 1.5 V. In contrast, tremendous oxidation of the commercial catalyst is observed (FIG. 8) due to the presence of large oxidation current.

Those comparative experiments stated above clearly indicate that mixed-valence platinum phosphate catalyst minimizes the formation of oxide.

### EXAMPLE 6

### Demonstration of Higher Current Density Per Gram Platinum

The experiments described above clearly show that the leveling current due to oxygen reduction in FIG. 10 is not 2.5-times more than in FIG. 9 as expected based on the amount of platinum catalyst loaded on to the electrode. The current density calculated at 700 mV for the mixed-valence catalyst appears to be at least three-times more than the commercial catalyst.

### EXAMPLE 7

### Oxygen Reduction Efficiency

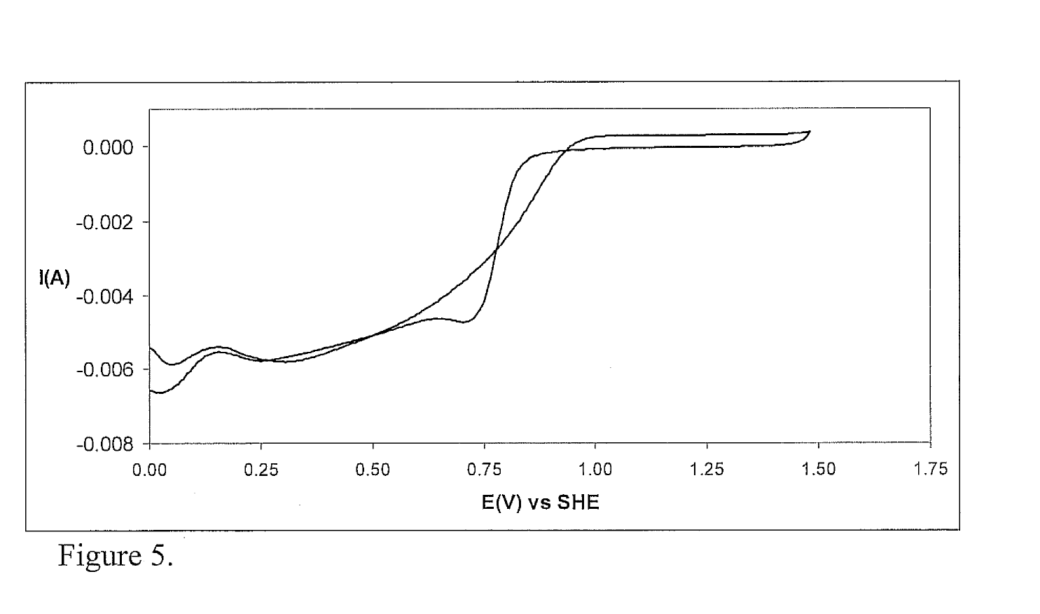

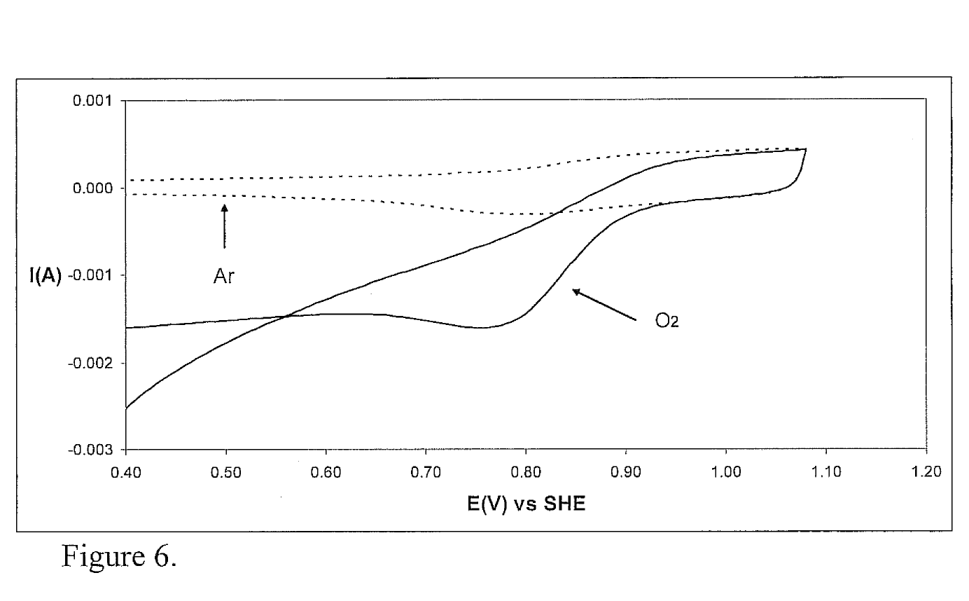

Steady state voltammetry experiments were performed to demonstrate unusual oxygen reduction efficiency. Like RDE experiments, current-potential curves were recorded in argon and oxygen purged solutions both for the commercial and platinum phosphate composite catalyst. For the platinum phosphate catalyst, in the forward scan (starting 1.5 V and scanning toward 0.0 V) for oxygen saturated cells revealed a steady increase in current from potential 1.0 to 0.9 followed steep rise in current up to 0.74 V and then a small decrease followed by small but continuous increase rather than a decrease in current (FIG. 4), red curve forward scan. In the reverse scan (starting at 0.0 V and moving toward 1.5 V), a continuous decrease in current until 0.9 V followed by a level-off of current in the region above 0.9 V was observed (FIG. 4, red curve reverse scan). The current-voltage curves, recorded by forward and reverse scans, in argon purged solution are also displayed in FIG. 4 (blue curves). The blue curves exhibit conventional features due to the formation and depletion of platinum oxide layer in the forward scan and reverse scans. However, this oxide layer is very small as revealed by the presence of small current at 0.8 V. The net current-voltage curves, obtained by subtracting currents in argon solution from oxygen saturated solution at every potential, is shown in FIG. 5. In FIG. 6, the scanning rate was 25 mV/s. The blue plot is taken in the absence of oxygen (argon purged) and the red curve is in the presence of oxygen. Note that the current levels off at 0.75 V and did not decline at voltages less than 0.75 V. When the experiments were conducted by using higher scan rates, similar leveling off features were observed.

The continuous increase followed by an almost leveling off of current (FIGS. 4 & 5) in the present invention is due to the continuous supply of oxygen at the electrode surface due the activation of mixed-valence composite catalyst and perhaps augmented by oxidation of water which remained abundant in the cell. The participation of the activated mixed valence platinum phosphate layer is verified based on the nature of current-voltage curve in the reverse scan, i.e., varying the potential from negative values to the positive value, 1.5 V. vs. SHE as shown in FIGS. 4 and 5. As can be seen from FIG. 5, the current values in the reverse scan up to 0.9 V do not reflect any anodic current as commonly observed for all electrocatalysts reported to date, rather it displays almost equal reduction currents as was observed in the forward scan. This behavior is seen at all scan rates from 10 mV/s to 100 mV/s. These data imply that that several different catalysts are participating in oxygen reduction reaction and perhaps water is continuously oxidized at the thin-film surfaces to supply oxygen which is reduced to generate current.

To compare the performance of our activated catalysts, identical experiments were performed with 40% Pt/C (Alfa Asear) catalyst which is commonly used in commercially available fuel cells. In these experiments, platinum catalyst (Alfa Asear) ink was spread on a carbon surface with platinum loadings higher than those thin-films described in the previous section. FIG. 8 shows a typical current-voltage response in the forward scan (going from positive to negative potentials). In the argon purged solution, a large reduction of oxide layer was observed. In the oxygen saturated solution, the current initially increases in the region 0.9 to 0.7 V due to oxygen reduction followed by sharp decrease in current due to the depletion of oxygen at the electrode surface. Note that two reduction peaks of almost equal current, one for the oxygen reduction and the other for the platinum-oxide reduction, were observed. These data imply that as much as 40% of the platinum surface was covered by the oxide which is not an oxygen reduction catalyst. In the reverse scan, the current rapidly decreases below the zero base-line.

### EXAMPLE 8

### Minimization of Hydrogen Adsorption Property

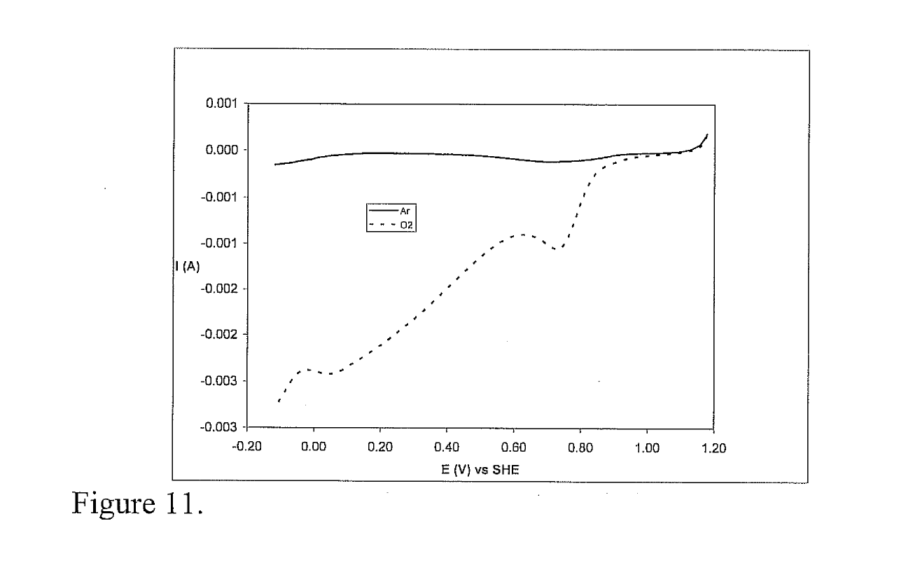

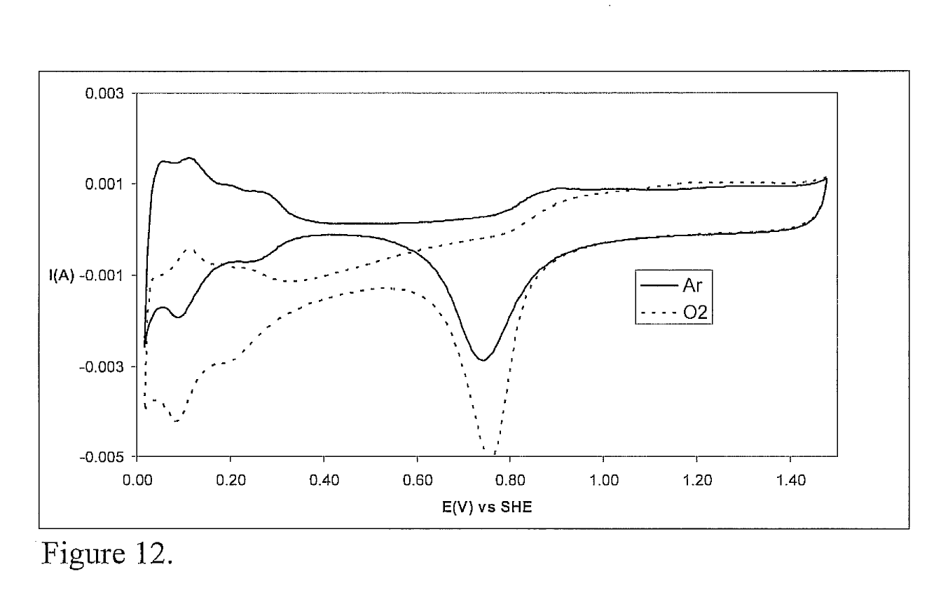

Hydrogen adsorption and desorption properties for two electrocatalysts prepared with two different compositions are shown in FIGS. 11 and 12. These experiments are conducted using a working electrode containing the electrocatalyst, a Pt-wire as an auxiliary electrode, and Hg/HgSO4 as the reference electrode. A solution of 0.5 M H₂SO₄ was used as an electrolyte and the solution was purged with ultrapure argon for 45 min. The potential was scan at a rate of 10 mV/s from positive to negative direction and currents were measured at different potential. FIGS. 11 and 12 show the current-potential plots for two different electrocatalyst. Hydrogen adsorption on platinum surface is characterized by several adsorption desorption peaks in the voltage range 0.0 to 0.4 V. In FIG. 12, the electrocatalyst clearly shows the hydrogen adsorption/desorption features at 0.25 and 0.08 V in the reduction side and 0.18, 0.21, and 0.27 V on the oxidation side indicating substantial metallic character. In FIG. 12, note that distinct hydrogen adsorption peaks are present due to the presence of metallic platinum in the composite. In FIG. 11, those features are barely observed, indicating that the mechanism of catalysis is different than platinum metal catalysts. Note that hydrogen adsorption properties are strongly observed in commercial catalyst presented in FIG. 8.

### EXAMPLE 9

### Single Cell Open Circuit Voltage Measurement and Performance Evaluation

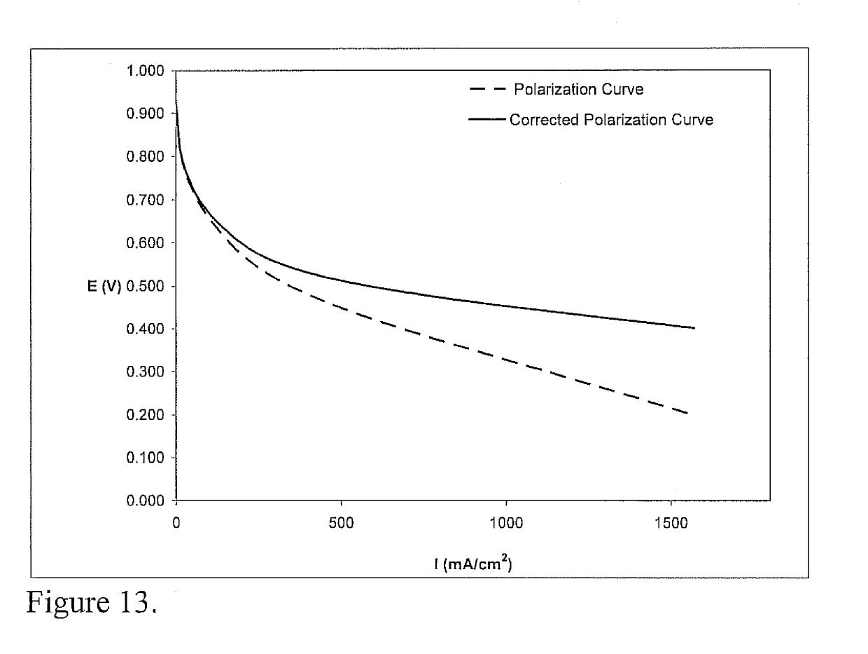

The cell performance measurements of all MEAs were conducted at 60° C. and 80° C. using H₂/O₂ with flow rates of 0.2 L/min for both H₂ and O₂, with both gases humidified to 100% relative humidity (RH) using a Fuel Cell Test Station 890CL (Scribner Associates Inc.). For the cathode electrochemically-active surface area measurements, a typical half-cell configuration was used by passing nitrogen at the cathode and hydrogen at the anode by coupling Corrware (Scribner Associates Inc.) and SI 1287 (Solatron Analytical) potentiostat at scan rate 30 mV/s between 0 to 0.8 V. The cell performance curves are shown in FIG. 13. In FIG. 13, the red curve represents non-IR free performance and the yellow curve represents IR free cell performance. The cathode was prepared with a platinum phosphate composite catalyst with platinum loading of 0.1 mg/cm². The open circuit voltage at 80° C. was observed to be 0.98 V. Note that the performance was measured with five-times less platinum loading (0.1 mg/cm2) than commercial catalyst.

The above experiment was performed to demonstrate that the metal phosphate composite catalyst functions effectively in the proton exchange membrane fuel cell. However, no attempts were made to optimize the performance and hence the power densities reflected in FIG. 13 can only be viewed as the evidence of performance, rather than a measure of total capacity of the catalyst. Optimization of power density would require further engineering including fabrication, mounting, control of humidity, and other parameters that control the power density.

### EXAMPLE 10

### Oxygen Reduction Efficiency of Mixed Metal Phosphate Composite Catalyst

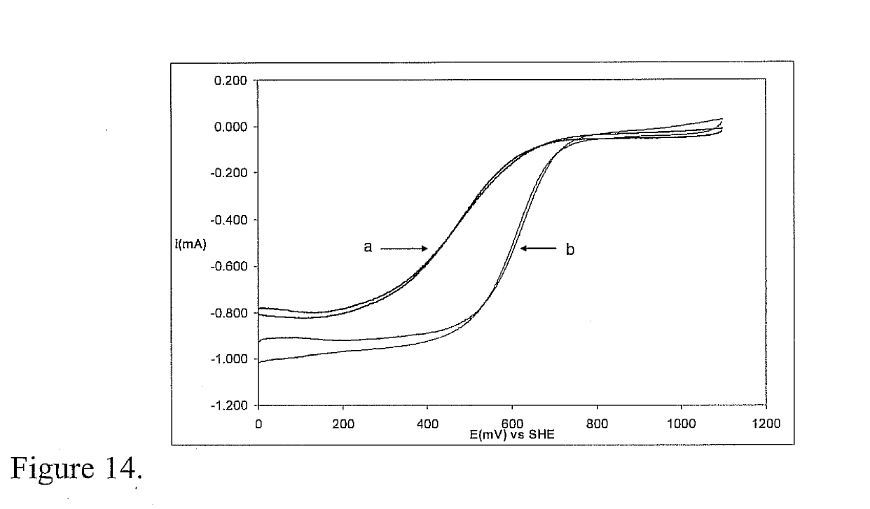

The oxygen reduction ability of the mixed metal phosphate composite was evaluated by the three-electrode system outlined in Example 3 except that the working electrode was the mixed-metal phosphate composite loaded on a variety of carbon surfaces. FIG. 13 shows the enhancement of oxygen reduction when mixed-valence platinum phosphate species is coated with ruthenium. Note that ruthenium does not enhance oxygen reduction on platinum metal catalysts. FIG. 14 shows the oxygen reduction ability of the iron coated platinum phosphate composite catalyst. Here again, some enhancement was also observed.

### EXAMPLE 11

### Methanol Oxidation

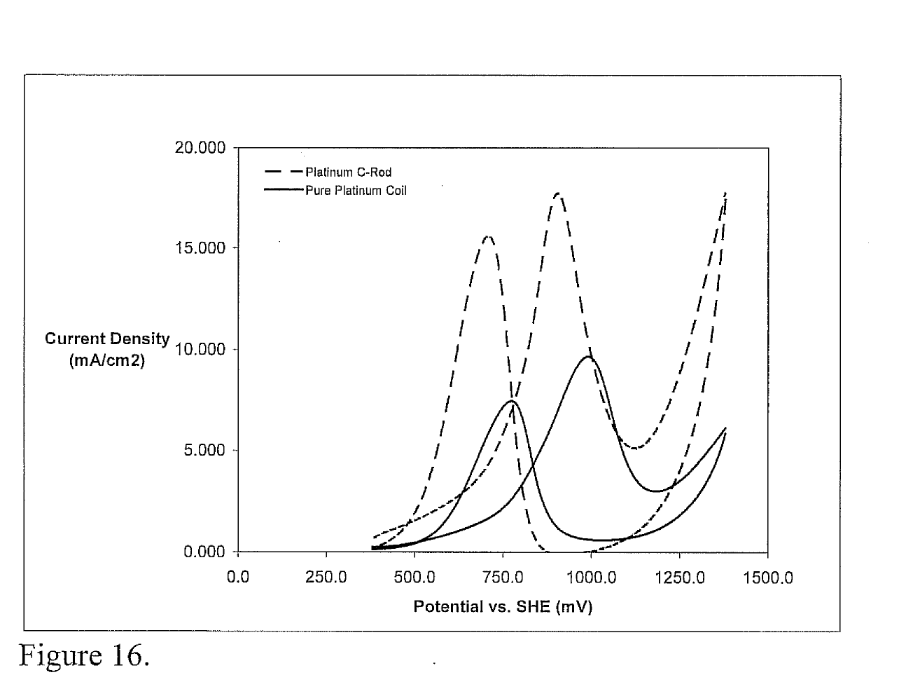

Methanol oxidation experiments were performed on an electrochemical analyzer —CH Instruments 1140A Potentiostat using 1.0 M in 0.5 M H₂SO₄. The three electrode setup included a gold coil as a counter electrode, Hg/HgSO₄ (saturated with sulphuric acid) as the reference electrode and carbon surfaces loaded with composite catalyst as the working electrode. Both the electrolyte (0.5 M H₂SO₄) and electrolyte plus methanol (1.0M) solutions were saturated with argon by bubbling ultra-pure argon for 30 minutes. The voltage was scanned from 180 mV to 1180 mV vs. SHE at variable scan rates, 10 mV/s to 100 mV/s. The current-voltage plots shown in FIG. 16 exhibits net current due to methanol oxidation which was obtained by subtracting the current obtained from the control experiment in electrolyte only.

The voltammograms obtained from methanol oxidation using the composite catalyst was compared with those obtained using a pure metallic platinum wire. In this case, Pt-wire was used as the working electrode. The auxiliary and reference electrodes remained the same.

The two peaks observed at 908 mV and 708 mV for the composite catalyst are due to the methanol oxidation and CO oxidation. These two peaks can be compared with the corresponding two peaks at 990 mV and 708 mV for the bare platinum wire. Note that the position of the methanol oxidation peak has been shifted 80 mV toward less positive voltage indicating that the platinum-phosphate composite is a better catalyst than platinum metal. Second, repeated scans on the composite catalyst did not show any signs for deactivation of the composite catalyst due to CO poising. Furthermore, when ruthenium was incorporated into the metal phosphate composite, no additional advantages in CO oxidation or potential shifting towards less potential were gained. These features indicate that metal phosphate catalyst is superior over other methanol oxidation catalyst.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention may be practiced otherwise than as specifically described.

### REFERENCES

### Patent References

1. R. N. Bose and A. Bose, “Metal Coated Carbon Surfaces for Use in Fuel Cells”, U.S. patent application Ser. No. 10/539,024
2. R. J. Allen and R. Giallombardo, U.S. Pat. No. 6,077,621 (2000).
3. C. A. Cavalca, J. H. Arps, and M. Murthy, U.S. Pat. No. 6,300,000 (2001)
4. S. S. Mao, G. M. Haugen, K. A. Lewinski, M. K. Debe, U.S. Pat. No. 99,312,512 (2000).
5. A. Cisar, O. J. Murphy, E. Clarke, U.S. Pat. No. 6,838,205 (2005).
6. Z. Piotr and R. Bashyam, U.S. Patent Application No. 0070082253, (2007)
7. Z. Piotr and R. Bashyam, U.S. Patent Application No. 0070082804 (2007)

### Other References Cited

1. R. N. Bose, R. E. Viola and R. D. Cornelius, J. Am. Chem. Soc., 1984, 106, 3336-3344.
2. R. N. Bose, R. D. Cornelius and R. E. Viola, Inorg. Chem., 1985, 24, 3989-3996.
3. H. A. Gasteiger, S. S. Kocha, B. Sompalli, F. T. Wagner, Applied Catalyst B: Environmental, 2005, 56, 9-35
4. A. F. Gulla, M. S. Saha, R. J. Allen, and S. Mukerjee, Electrochem. Solid State Lett., 2005, 8, A504-508.
5. A. B. Bose, M. Sarkar, and R. N. Bose, J. Power Sources, 2006, 157, 188-192.
6. L. Xiong and A. Manthiram, J. Electrochem. Soc., 2005, 152, A697-A703
7. P. J. Ferreira, G. J. LaO, Y. Shao-Horn, D. Morgan, R. Makharia, S. Kocha, and H. A. Gasteiger, J. Electrochem. Soc., 2005, 152, A2256-A2271
8. V. Raghuveer, A. Manthiram, and A. J. Bard, J. Phys. Chem. B, 2005, 109, 22909-22912.
9. V. Stamenkovic, B. Fowler, B. M. Mun, G. Wang, P. N. Ross, C. A. Lucas, and N. M. Markovic, Science, 2007, 315, 493-496.

We claim:

1. A thin-film electrocatalyst of a platinum phosphate composite surface, said platinum phosphate composite surface being entirely oxygen reductive.

2. The thin-film electrocatalyst of claim 1, wherein said platinum phosphate composite surface is further defined as a mixed valence platinum surface.

3. The thin-film electrocatalyst of claim 1, wherein said platinum phosphate composite surface is derived from mixed valence platinum oligomeric blue complexes.

4. The thin-film electrocatalyst of claim 3, wherein said platinum phosphate composite surface is platinum phosphate blue.

5. The thin-film electrocatalyst of claim 1, wherein said platinum phosphate composite surface further includes bound phosphate.

6. The thin-film electrocatalyst of claim 1, further comprising at least one transition metal chosen from the group consisting of chromium, cobalt, iron, nickel, palladium, iridium, and ruthenium.

7. The thin-film electrocatalyst of claim 1, wherein said platinum phosphate composite surface has a reduced affinity to absorb carbon monoxide.

8. The thin-film electrocatalyst of claim 1, wherein said platinum phosphate composite surface has oxidation states of (II) and (III).

9. The thin-film electrocatalyst of claim 1, further including means for protecting said platinum phosphate composite surface from oxidation at high voltages.

10. The thin-film electrocatalyst of claim 1, wherein said platinum phosphate composite surface minimizes hydrogen adsorption/desorption properties.

11. A tunable platinum phosphate composite surface, said platinum phosphate composite surface being entirely oxygen reductive.

12. A substrate including deposited thereon a thin-film electrocatalyst a platinum phosphate composite surface, said platinum surface being entirely oxygen reductive.

13. The substrate of claim 12, chosen from the group consisting of graphite carbon, carbon paper, porous carbon powder, carbon cloth, and ionomers.

14. The substrate of claim 12, wherein said thin-film electrocatalyst is present in the amount of 0.03 mg/cm² to 0.22 mg/cm².

15. The substrate of claim 12, wherein said thin-film electrocatalyst is deposited on said substrate by reductive electropolymerization.

16. The substrate of claim 12, further including deposited thereon at least one transition metal chosen from the group consisting of chromium, cobalt, iron, nickel, palladium, iridium, and ruthenium.

17. A fuel cell including at least one substrate of claim 12.

18. The fuel cell of claim 17, further defined as including three-phase components of a carbon powder, an ionomer, and electrical conductor each having deposited thereon the thin-film electrocatalyst of claim 1.
